(19) United States
(12) Patent Application Publication
(10) Pub. No.: US 2004/0052721 A1
(43) Pub. Date: Mar. 18, 2004

(54) Dielectric particles having passivated surfaces and methods of forming same

(76) Inventors: Jeffrey A. Kerchner, Fleetwood, PA (US); Sridhar Venigalla, Macungie, PA (US)

Correspondence Address: Martha Ann Finnegan, Cabot Corporation, 157 Concord Road, Billerica, MA, 01821, US

(21) Appl. No.: 10/244,041

(22) Filed: Sep. 13, 2002

(51) Int. Cl. C01G 23/04; C01G 23/00

(52) U.S. Cl. 423/598

(57) ABSTRACT

The invention provides dielectric (e.g., barium titanate-based) particles having passivated surfaces. The surfaces may be passivated, for example, using methods that limit the dissolution of divalent metals (e.g., barium) from the particle surfaces in subsequent processing steps. In some methods, the surfaces are passivated by washing the particles to form a divalent metal-depleted surface region. In other methods, the particles may be coated with a divalent metal insoluble compound or a divalent metal free compound. Advantageously, the surface passivated particles may be uniformly dispersed to form dispersions that are stable for long periods of time and may be further processed to form articles having particles uniformly dispersed therein. The particles are particularly suitable in the formation of polymer/dielectric composites that may be used in embedded capacitor applications.

### FIELD OF INVENTION

The present invention relates generally to dielectric particles and, more particularly, to barium titanate-based particles having passivated surfaces and methods of forming such particles.

### BACKGROUND OF INVENTION

Barium titanate-based compositions, which include barium titanate (BaTiO₃) and its solid solutions, may be used as dielectric materials in electronic devices. The barium titanate-based compositions are typically produced as small particles which are further processed to form the desired structure. In some cases, the particles are distributed in a polymeric material to form a polymer/dielectric composite. Such composites may be used as a dielectric layer, for example, in printed circuit boards. The composite dielectric layer may function as an embedded capacitor which can have property and processing advantages over conventional capacitor devices that are mounted on top of printed circuit boards. Suitable polymeric materials in embedded capacitor applications include epoxies, polyimides, and polyamides, amongst others.

When processing to form a polymer/dielectric composite, barium titanate-based particles are often times dispersed in a fluid to form a dispersion. Precursors of the polymeric material (e.g., monomer) also are typically added to the dispersion. Other additives may also be added to the dispersions including polymeric binders, dispersants, and catalysts which facilitate the polymerization reaction. Such dispersions can be cast and, then, heated to polymerize the polymeric material precursors and to evaporate fluid present in the cast layer. After polymerization, a composite layer that includes the barium titanate-based particles distributed throughout a polymer matrix is formed.

In some processes it is advantageous to uniformly disperse the barium titanate-based particles in the dispersion so that the resulting material has the particles uniformly distributed therein. For example, in certain polymer/dielectric composite applications, it is desirable for the particles to be relatively uniformly distributed throughout the polymer matrix to provide relatively consistent electrical properties across the composite and to enable formation of thin composite layers. During processing of dispersions of barium titanate-based particles, particle agglomeration and/or cross-linking of polymeric material (e.g., binders) in the dispersion can occur which can limit the uniformity of particle distribution in the dispersion and the resulting article.

### SUMMARY OF INVENTION

The invention provides dielectric particles having passivated surfaces and methods of processing such particles.

In one aspect, a method is provided for processing dielectric particles having an ABO₃ composition, wherein A is at least one divalent metal and B is at least one tetravalent metal. The method comprises washing the dielectric particles to deplete at least one divalent metal from a surface region of the dielectric particles and to reduce a ratio of divalent metal concentration to tetravalent metal concentration in the composition to less than 0.990.

In another aspect, dielectric particles are provided. The dielectric particles have an ABO₃ composition, wherein A is at least one divalent metal and B is at least one tetravalent metal. The dielectric particles have a surface region depleted of divalent metal and a ratio of divalent metal concentration to tetravalent metal concentration of less than 0.990.

In another aspect, a polymer/dielectric composite comprising dielectric particles distributed in a polymer matrix is provided. The dielectric particles have an ABO₃ composition, wherein A is at least one divalent metal and B is at least one tetravalent metal. The dielectric particles have a surface region depleted of divalent metal and a ratio of divalent metal concentration to tetravalent metal concentration of less than 0.990.

Other aspects, embodiments, and features of the invention including other methods, particles having other characteristics, and articles that include such particles will become apparent from the following detailed description. All references incorporated herein are incorporated in their entirety. In cases of conflict between an incorporated reference and the present specification, the present specification shall control.

### BRIEF DESCRIPTION OF DRAWINGS

FIG. 1 schematically shows dielectric particles having a barium depleted surface region according to one embodiment of the present invention.

### DETAILED DESCRIPTION OF INVENTION

The invention provides dielectric (e.g., barium titanate-based) particles having passivated surfaces. The surfaces may be passivated, for example, using methods that limit the dissolution of divalent metals (e.g., barium) from the particle surfaces in subsequent processing steps. In some methods, the surfaces are passivated by washing the particles to form a divalent metal-depleted surface region. In other methods, the particles may be coated with a divalent metal insoluble compound or a divalent metal free compound. Advantageously, the surface passivated particles may be uniformly dispersed to form dispersions that are stable for long periods of time and may be further processed to form articles having particles uniformly dispersed therein. The particles are particularly suitable in the formation of polymer/dielectric composites that may be used in embedded capacitor applications.

The dielectric particles may have an ABO₃ composition, where A represents one or more divalent metal (e.g., Ba, Ca, Pb, Sr, Mg, etc.) and B represents one or more tetravalent metal (e.g., Ti, Zr, Sn, etc.). Barium titanate-based dielectric compositions, as described further below, are preferred in some embodiments of the invention. Other suitable dielectric compositions include lead magnesium niobate, amongst others. For ABO₃ compositions, the A/B ratio is defined as the ratio of the divalent metal (A) concentration to the tetravalent metal (B) concentration. The A/B ratio may be measured, for example, using x-ray fluorescence (XRF).

As used herein, “barium titanate-based” particle compositions refer to barium titanate, solid solutions thereof, or other oxides based on barium and titanium having the general structure ABO₃, where A represents one or more divalent metal including barium and, optionally, one or more of calcium, lead, strontium, magnesium and zinc; and B represents one or more tetravalent metal including titanium and, optionally, one or more of tin, zirconium, niobium, and hafnium. In some cases, barium titanate (BaTiO₃) particles are preferred. One type of barium titanate-based composition has the structure Ba₍₁₋ₓ₎AₓTi_{(1-y)}B_{y}O₃, where x and y can be in the range of 0 to 1, where A represents one or more divalent metal other than barium such as lead, calcium, strontium, magnesium and zinc and B represents one or more tetravalent metals other than titanium such as tin, zirconium and hafnium. Where the divalent or tetravalent metals are present as impurities, the value of x and y may be small, for example less than 0.1. In other cases, the divalent or tetravalent metals may be introduced at higher levels to provide a significantly identifiable compound such as barium-calcium titanate, barium-strontium titanate, barium titanate-zirconate and the like. In still other cases, where x or y is 1.0, barium or titanium may be completely replaced by alternative metal(s) of appropriate valence to provide a compound such as lead titanate or barium zirconate. In other cases, the compound may have multiple partial substitutions of barium or titanium. An example of such a multiple partial substituted composition is represented by the structural formula Ba_{(1-x-x′-x″)}PbₓCa_{x′}Sr_{x″}O.Ti_{(1-y-y′-y″)} Sn_{y}Zr_{y′} Hf_{y″}O₂, where x, x′, x″, y, y′, and y″ are each greater than or equal to 0. In many cases, the barium titanate-based particles have a perovskite crystal structure, though in other cases the particles may not.

The dielectric particles may have a variety of different particle characteristics. The dielectric particles (e.g., barium titanate-based particles) typically have an average particle size of less than about 5.0 microns; in some cases, the average particle size is less than about 1.0 micron; in some cases, the average particle size may be less than about 0.5 micron; in some cases, the average particle size is less than about 0.25 micron; and, in some cases, the average particle size is less than about 0.10 micron. As used herein, the average particle size refers to the average primary particle size. The average particle size may be determined using standard techniques, for example, by SEM analysis.

In some embodiments, the dielectric primary particles will agglomerate and/or aggregate to form aggregates and/or agglomerates of aggregates. At times, it may be preferable to use particles that are not strongly agglomerated and/or aggregated such that the particles may be relatively easily dispersed, for example, by high shear mixing.

The particles may have a variety of shapes which may depend, in part, upon the process used to produce the particles. The particles may be equiaxed and/or substantially spherical, in particular, if the particles are hydrothermally produced as described further below. When the particles are milled, they generally have an irregular, non-equiaxed shape.

The particles may be produced according to any technique known in the art including hydrothermal processes, solid-state reaction processes, sol-gel processes, calcination by carbonate decomposition processes, and oxalate-based processes. As described further below, surfaces of the particles are passivated in subsequent processing step(s). In some embodiments, it may be preferable to produce the barium titanate-based particles using a hydrothermal process.

Hydrothermal processes generally involve mixing a barium source with a titanium source in an aqueous environment to form a hydrothermal reaction mixture which is maintained at an elevated temperature. The barium source, for example, may be barium hydroxide solution heated to between about 70 degrees C. and 110 degrees C. The titanium source, for example, may be a hydrous titania gel produced by mixing titanium oxychloride (TiOCl₂) with water, and then adding ammonia hydroxide to increase the pH of the solution to precipitate the titania gel. Barium reacts with titanium to form barium titanate particles which remain dispersed in the aqueous environment to form a slurry. The particles in the slurry are further processed as described further below. When forming barium titanate solid solution particles hydrothermally, sources including the appropriate divalent or tetravalent metal are also added to the hydrothermal reaction mixture. Certain hydrothermal processes may be used to produce substantially spherical barium titanate-based particles having an average particle size of less than 0.5 micron and a uniform particle size distribution. Suitable hydrothermal processes for forming barium titanate-based particles have been described, for example, in commonly-owned U.S. Pat. Nos. 4,829,033, 4,832,939, and 4,863,883, which are incorporated herein by reference in their entireties.

In some embodiments, the particles may be subjected to a heat treatment step prior to surface passivation. The heat treatment step involves heating the particles, for example, to a temperature between about 700° C. and about 1150° C. to increase average particle size. The increased average particle size can improve the electrical properties (i.e., dielectric constant and dissipation factor) of the heat-treated composition after the coating process, as compared to the compositions that are not heat treated. A suitable heat treatment process of barium titanate-based particles is described in commonly-owned, co-pending U.S. patent application Ser. No. 09/689,093, which was filed on Sep. 12, 2000, and is incorporated herein by reference in its entirety. When hydrothermally-produced barium titanate-based particles are subjected to a heat treatment step, the water in the slurry may be removed (e.g., by filtering or decanting) and the particles may be dried at a lower temperature prior to heat treatment.

As described above, the particles are subjected to a surface passivation step. Some methods of the present invention involve passivating surfaces of the particles to limit the dissolution of divalent metals, such as barium, from the particle surfaces. Thus, the formation of divalent metal ions in subsequent processing steps is limited. It should be understood that the passivating methods of the invention are also suitable for limiting the dissolution of divalent metals other than barium including calcium, lead, strontium, or magnesium, which may be present in the particle composition.

In some methods of the invention, particle surfaces are passivated in a washing step. During washing, divalent metals at or near the particle surface are dissolved in the washing liquid. The washing conditions (e.g., type of washing liquid, washing time, number of washing steps, etc.) may be selected to achieve a desired depletion depth, as described further below. It should be understood that other elements of the particle composition may also be dissolved in the washing step. For example, chlorine, which may be residual from production of the particles, may be dissolved in the washing step.

The divalent metals of the particle composition must be sufficiently soluble in the washing liquid. A number of different liquids may be suitable including, but not limited to, deionized water, acidified water (e.g., water acidified with acetic acid), or buffered ammoniated water. The type of washing liquid depends, in part, on process conditions and the desired barium depletion depth. In certain processes, acidified water may be preferred because barium is highly soluble in acidified water. The acidified water may have a pH of less than 5, for example, about 3.

The washing liquid may be at room temperature or, if desired, may be heated to an elevated temperature. Washing with a heated liquid may increase divalent metal solubility, but also can increase cost and complexity of the process.

Any suitable washing technique may be used. In some processes, washing is done by adding the particles to a washing liquid (e.g., acidified water) to form a mixture in a tank. The particles may be present in the mixture in an amount of less than about 20 percent by weight of the mixture. However, it should be understood that mixtures including higher particle weight percentages may also be used. The mixture may be stirred, for example, using a high shear mixer for a desired time period (e.g., about several minutes). After stirring, the mixture may be filtered to remove excess water, thus, forming a wet cake. The wet cake may include, for example, between about 60 and about 70 percent particles by weight. If desired, the washing process may be repeated by adding a washing liquid to the wet cake to form a mixture and repeating the above steps.

After washing, the particles in the wet cake may be re-dispersed in another liquid to form a dispersion without drying. The dispersion may be further processed, as described further below, or provided to a third party for further processing. In other cases, the particles in the wet cake may be dried. The dried particles may be further processed, as described further below, or provided to a third party for further processing. The dried particles may be subjected to an optional heat treat step. In this heat treat step, the particles are heated to a temperature, for example, between about 200 degrees C. and 700 degrees C. The heat treat step is conducted to remove hydroxyl groups residual from the washing process and/or to crystallize the depleted surface region, for example, to form TiO₂.

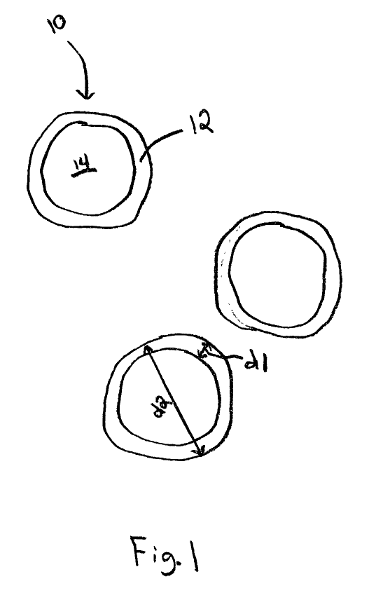

Referring to FIG. 1, after washing, particles 10 include a divalent metal depleted surface region 12. For example, in BaTiO₃ particles, the depleted surface region is depleted of barium. The depleted surface region includes a lower divalent metal concentration than that of a core region 14 of the particles. The depleted surface region extends a distance (d1) from the particle surface to a depth at which the divalent metal concentration is equal to the divalent metal concentration in the core region.

In some cases, the depleted surface region may be free of divalent metals. However, in other cases, divalent metals may still be present in the depleted surface region at lower concentrations than in the core region. When present in the depleted surface region, the concentration of the divalent metal may be graded in a manner such that there is a greater divalent metal concentration at increasing depths.

Washing is conducted to achieve a desired depletion depth that sufficiently limits divalent metal dissolution in subsequent processing steps in which the particles are dispersed. Divalent metal dissolution is sufficiently limited when problems that would otherwise arise from dissolution are prevented. Such problems are observed when dispersing non-washed particles and include particle agglomeration and/or cross-linking of polymeric material in dispersions of the particles.

The desired depletion depth of the surface region depends, in part, on the subsequent processing step conditions including the type of liquid in which the particles are dispersed, the type of polymeric material in the dispersion, the pH of the dispersion, the temperature of the dispersion, and other factors. Thus, different depletion depths may be required for different processes.

In some cases, the desired average depletion depth is greater than about 0.5% of the average particle size (d2, FIG. 1). In some cases, greater depletion depths are required to prevent the above-described problems. For example, in some cases, the desired average depth is greater than about 1.0% of the average particle size; or, greater than about 3.0% of the average particle size.

The desired average depth is typically less than about 10% of the average particle size. Depletion average depths of greater than about 10% may adversely effect electrical properties of devices formed from such particles. In certain embodiments, the desired average depth of the surface region is between about 0.5% and about 10% of the average particle size.

The average depletion depth may be measured, for example, using high resolution TEM. In a TEM micrograph, the depleted surface region is indicated by a diffuse region around the particle diameter which does not contain the lattice fringe present within the particle. The average depleted depth is determined by the averaging surface region depths of a representative number of particles.

The majority number of particles (e.g., greater than 50% in some cases; greater than 75% in some cases; or, greater than 95% in some cases) typically have the desired surface region depth. However, it should be understood that a minority number of particles may not have the desired surface region depth as a result of processing inhomogeneity.

As a result of depletion of divalent metals at the particle surface, the washed particles have an A/B ratio of less than 1.000. As described above, the A/B ratio is the ratio of the divalent metal (A) concentration to the tetravalent metal (B) concentration in the particle composition. The A/B ratio may also be used to quantify the amount of divalent metal depletion. A lower A/B ratio is indicative of greater divalent metal depletion.

Washing the barium titanate-based particles decreases the A/B ratio at least 0.01. In some processes, the particles are washed to achieve an A/B ratio of less than 0.990. For these processes, an A/B ratio of 0.990, or greater, is indicative of insufficient divalent metal depletion. Insufficient divalent metal depletion during washing can result in excessive dissolution of divalent metals when the particles are dispersed in a liquid in subsequent processing steps. The excessive dissolution can lead to the above-described problems including particle agglomeration and/or cross-linking of polymeric material in the dispersion.

Other processes may require the particles to be washed to achieve lower A/B ratios. For example, other processes involve washing the particle to achieve an A/B ratio of less than 0.980. For these processes, an A/B ratio of 0.980, or greater, is indicative of insufficient divalent metal dissolution which can result the in above-described problems.

Still other processes involve washing the particles to achieve an A/B ratio of less than 0.970. For these processes, an A/B ratio of 0.970, or greater, is indicative of insufficient divalent metal dissolution which can result the in above-described problems.

Different processes may require different maximum A/B ratios because the extent of divalent metal dissolution depends on the specific subsequent processing conditions (e.g., type of liquid particles are dispersed in, dispersion temperature, dispersion pH, and the type of polymeric material in the dispersion, amongst others). For example, processes having a maximum A/B ratio of 0.970 may subsequently expose particles to conditions that dissolve divalent metals to a greater extent than processes that have a maximum A/B ratio of 0.990. Furthermore, different processes may be able withstand greater amounts of divalent metal dissolution without the occurrence of the problems associated therewith.

The particle composition typically, though not always, has an A/B ratio of greater than about 0.900. A/B ratios of less than about 0.900 may adversely effect electrical properties of devices formed from such particles.

In some methods of the invention, particle surfaces are passivated by coating particle surfaces with a divalent metal compound that is insoluble in liquids (e.g., aqueous or non-aqueous) in which the particles are to be further processed. Such divalent metal compound coatings may be formed, for example, by dispersing particles in an aqueous solution and adding a passivating agent to the dispersion. The passivating agent may react with the divalent metal (e.g., barium) at the surface to form a coating of an insoluble compound. Because the coating is insoluble, dissolution of the divalent metal is prevented or limited in subsequent processing steps.

In one embodiment, oxalic acid is added as a passivating agent to a dispersion of barium titanate particles. Oxalic acid reacts with barium at the particle surfaces to form a coating of barium oxalate on the particles. Barium oxalate is generally insoluble in aqueous solutions and a number of non-aqueous liquids which may be used in subsequent processing steps. Other suitable passivating agents and methods of using same with barium titanate-based particles have been described in U.S. Pat. No. 6,214,756, which is incorporated herein by reference in its entirety.

In some methods of the invention, particle surfaces are passivated by coating particle surfaces with a compound that is free of divalent metals. Because divalent metals are not present at particle surfaces, such coatings limit divalent metal dissolution from the particle in subsequent processing steps. The coating may generally be any inert compound that does not adversely effect use of the particulate composition in the desired application. In some methods, the coating may be silica. Any suitable technique may be used to form the coating including precipitation techniques.

In some of the coating methods discussed above, the coating preferably encapsulates the entire particle surface. Thus, in these methods, the particle surfaces do not include exposed regions which are susceptible to divalent metal dissolution. The coatings also may be of sufficient thickness to prevent diffusion of divalent metal therethrough and subsequent dissolution. The coating thickness, for example, may be between about 0.5% and about 10% of the particle diameter.

The particles having passivated surfaces may be further processed as desired. In some cases, the particles are dispersed in aqueous solutions during subsequent processing steps. In other cases, the particles are dispersed in non-aqueous solvents during subsequent processing steps. In either case, divalent metal dissolution in the aqueous solution or non-aqueous solvent is limited or prevented by the surface passivation techniques described herein.

Further processing may include formation of a polymer/dielectric composite. Suitable processes for forming polymer/dielectric composites using the particles described herein have been described, for example, in commonly-owned, co-pending, U.S. patent application Ser. No. 10/150,761, which was filed on May 17, 2002, and commonly-owned, co-pending, U.S. Provisional Patent Application Serial No. 60/323,946, which was filed on Sep. 21, 2001, which are incorporated herein by reference in their entireties. Such processes may involve forming an aqueous mixture of dielectric (e.g., barium titanate-based) particles and replacing at least a portion of water in the mixture with a non-aqueous solvent. The processes may also include drying the particles and mechanically milling the particles to reduce agglomeration.

In some processes for forming polymer/dielectric composite, the particles are typically dispersed in a fluid in which a polymeric material precursor (e.g., monomer) is dissolved. The selection of solvent and polymeric material precursor depends upon the application. Suitable polymeric materials include epoxies, polyamides, and polyimides, amongst others. One suitable solvent (for epoxies, polyamides, and polyimides) is NMP (1-methyl, 2 pyrrolidinone), though it should be understood that a variety of other solvents may also be used. The dispersion is cast to form a layer which is heated to evaporate the solvent. The resulting composite structure includes the particles distributed uniformly throughout a polymer matrix. Such structures are particularly suitable for use in embedded capacitor applications.

Although it is described herein that the particles can be processed to form polymer/dielectric composites (e.g., for use in embedded capacitor applications), it should be understood that the particles may be further processed to produce any desired structure including dielectric layers in multilayer ceramic capacitor devices.

The present invention will be further illustrated by the following example, which is intended to be illustrative in nature and is not to be considered as limiting the scope of the invention.

### EXAMPLE

Barium titanate particles were subjected to a washing step according to one embodiment of the present invention. Properties of the washed particles were compared to un-washed particles to show that the washing step produced a barium depleted surface region and reduced barium dissolution in subsequent solutions including the particles.

Barium titanate particles were produced using a hydrothermal reaction. The particles had a particle size of between about 0.125 and about 0.150 micron. A fraction of the particles were subjected to a washing step and a fraction of the particles were not washed.

Washing was conducted as follows. Acetic acid was added to 2 liters of deionized water to form acidified water having a pH of about 3. 250 g of the barium titanate particles were added to the acidified water and emulsified for 2 minutes using a benchtop Ross-Silverson high shear mixer. The suspension was filtered through Whatman filter paper (#3) using a vacuum assisted, Buchner-style filter bottom located on top of an Erlenmeyer flask. The subsequent filtercake was collected and re-suspended in 1 liter of acidified water (pH of 3). Emulsification was performed for 2 minutes using the same emulsifier and filtration was repeated as described above. The wet cake was again collected and re-suspended in 2 liters of deionized water, emulsified and filtered. The re-suspension, emulsification, and filtration process was repeated two additional times to remove any previous residual acid.

After the washing step, 1 liter of ethanol (Fisher Scientific) was used to re-suspend the aqueous wet cake. This was followed by emulsification and filtration. Re-suspension in a second 1 liter of ethanol was followed by emulsification and a final filtration. The ethanol-based wet cake was then dried in a vacuum oven at 80 degrees C. overnight to form a powder. The powder was passed through a 100 mesh screen with ⅜″ zirconia media. The ethanol wash and screening were done to increase dispersibiliy of particles, though it is expected that these steps did not deplete barium from the surface of the particles.

Samples suitable for XRF analysis were prepared from washed particles and from unwashed particles. XRF analysis was conducted to determine the A/B ratio of each samples. The results are shown in Table 1.

Solutions were prepared using the washed particles and using unwashed particles to assess the extent of barium dissolution at room temperature. The solutions were prepared as follows. 0.5 g samples of washed and unwashed particles were weighed into separate cups using a Mettler analytical balance. 20 g of pure water (MilliQ purification system) was added to each cup. The cups were sonicated in an ultrasonic batch at room temperature for 1 hour. Solutions were drawn from cups using a syringe (no needle) and then passed through a PTFE 0.25 micron syringe. The solutions were filtered into a 50 ml polypropylene centrifuge tube. The conductivity and pH of each solution were measured. The results are shown in Table 1.

0.225 ml of 35% nitric acid was then added to each solution to prevent unwanted precipitation of barium. The barium concentration of each solution was then measured using ICP Spectroscopy. The results are shown in Table 1.

Solutions were prepared using the washed particles and using unwashed particles to assess the extent of barium dissolution at an elevated temperature. The solutions were prepared as follows. 0.5 g samples of washed and unwashed particles were weighed into fluorocarbon pressure vessels using a Mettler analytical balance. 20 g of pure water (MilliQ purification system) was added to each vessel. A Teflon stir bar was used to mix the mixture in each vessel. Each vessel was sealed and placed in a microwave station. The temperature was ramped to 120 degrees C. in 10 minutes and held for 2 hours. The sealed vessels were opened when the temperature dropped below 80 degrees C. Solutions were drawn from fluorocarbon cups using a syringe (no needle) and then passed through a PTFE 0.25 micron syringe. The solutions were filtered into a 50 ml polypropylene centrifuge tube. The conductivity and pH of each solution were measured. The results are shown in Table 1.

0.225 ml of 35% nitric acid was then added to each solution to prevent unwanted precipitation of barium. The barium concentration of each solution was then measured using ICP Spectroscopy. The results are shown in Table 1.

TABLE 1

| | | | | | | Ba | |
|---|---|---|---|---|---|---|---|
| | | | | Conductivity | | Concentration | |
| | A/B Ratio | pH | | (microSiemens) | | (ppm) | |
| Washed | 0.973 | 6.0 | (RT) | 4.7 | (RT) | 2.7 | (RT) |
| | | 6.1 | (120 C.) | 28 | (120 C.) | 15.5 | (120 C.) |
| Unwashed | 1.000 | 6.8 | (RT) | 15.6 | (RT) | 10.1 | (RT) |
| | | 9.3 | (120 C.) | 71.2 | (120 C.) | 39.6 | (120 C.) |

The results in Table 1 show that the washing step reduces the A/B ratio and reduces the dissolution of barium from the particles into a solution subsequently formed from the particles. The reduction in dissolution is shown by the lower barium concentration, lower conductivity and lower pH measured for solutions formed using washed particles as compared to solutions formed using unwashed particles. These trends were observed for the room temperature samples, as well as the high temperature samples. The results suggest that a washing step may effectively produce a barium depleted particle surface region which reduces barium dissolution in subsequent processing steps.

Although particular embodiments of the invention have been described in detail for purposes of illustration, various changes and modifications may be made without departing from the scope and spirit of the invention. Accordingly, the invention is not to be limited except by the appended claims.

What is claimed is:

1. A method of processing dielectric particles having an ABO₃ composition, wherein A is at least one divalent metal and B is at least one tetravalent metal, the method comprising:
washing the dielectric particles to deplete at least one divalent metal from a surface region of the dielectric particles and to reduce a ratio of divalent metal concentration to tetravalent metal concentration in the composition to less than 0.990.

2. The method of claim 1, wherein the dielectric particles are barium titanate-based particles.

3. The method of claim 1, wherein the surface region is depleted of barium.

4. The method of claim 1, wherein the surface region is free of divalent metal.

5. The method of claim 1, comprising washing the dielectric particles with acidified water to form the surface region.

6. The method of claim 5, wherein the acidified water has a pH of less than about 5.

7. The method of claim 1, comprising washing the dielectric particles with deionized water to form the surface region.

8. The method of claim 1, wherein the washing step comprises mixing the dielectric particles and a washing liquid in a tank and filtering the washing liquid to form a wet cake.

9. The method of claim 8, wherein the washing step further comprises mixing the wet cake and a washing liquid in a tank and filtering the washing liquid to form a second wet cake.

10. The method of claim 1, comprising washing the dielectric particles to reduce the ratio of divalent metal concentration to tetravalent metal concentration in the composition to less than 0.980.

11. The method of claim 1, comprising washing the dielectric particles to reduce the ratio of divalent metal concentration to tetravalent metal concentration in the composition to less than 0.970.

12. The method of claim 1, further comprising hydrothermally producing the dielectric particles.

13. The method of claim 1, further comprising drying the dielectric particles after washing to produce dried particles.

14. The method of claim 13, further comprising heating the dried particles to a temperature between about 200 degrees C. and about 700 degrees C.

15. The method of claim 1, further comprising, after washing, providing the dielectric particles to be dispersed in a liquid that includes a polymeric material or polymeric material precursor to form a dispersion.

16. The method of claim 15, wherein the dispersion is further processed to form a polymer/dielectric composite.

17. The method of claim 15, wherein the liquid is a non-aqueous solvent.

18. The method of claim 1, wherein the surface region has an average depth between about 0.5% and about 10% of the average particle size of the dielectric particles.

19. Dielectric particles having an ABO₃ composition, wherein A is at least one divalent metal and B is at least one tetravalent metal, the dielectric particles having a surface region depleted of divalent metal and a ratio of divalent metal concentration to tetravalent metal concentration of less than 0.990.

20. The dielectric particles of claim 19, wherein the surface region has a depth between about 0.5% and about 10% of the average particle size of the dielectric particles.

21. The dielectric particles of claim 19, wherein the dielectric particles are barium titanate-based particles.

22. The dielectric particles of claim 19, wherein the surface region is depleted of barium.

23. The dielectric particles of claim 19, wherein the surface region is free of divalent metal.

24. The dielectric particles of claim 19, wherein the dielectric particles have a ratio of divalent metal concentration to tetravalent metal concentration of less than 0.980.

25. The dielectric particles of claim 19, wherein the dielectric particles have a ratio of divalent metal concentration to tetravalent metal concentration of less than 0.970.

26. The dielectric particles of claim 19, wherein the dielectric particles are hydrothermally produced.

27. The dielectric particles of claim 19, wherein the dielectric particles are substantially spherical.

28. The dielectric particles of claim 19, wherein the dielectric particles have an average particle size of less than about 0.5 micron.

29. The dielectric particles of claim 19, wherein the dielectric particles have an average particle size of less than about 0.25 micron.

30. A polymer/dielectric composite comprising dielectric particles distributed in a polymer matrix, the dielectric particles having an ABO₃ composition, wherein A is at least one divalent metal and B is at least one tetravalent metal, the dielectric particles having a surface region depleted of divalent metal and a ratio of divalent metal concentration to tetravalent metal concentration of less than 0.990.

31. The polymer/dielectric composite of claim 30, wherein the dielectric particles are barium titanate-based particles.

32. The polymer/dielectric composite of claim 30, wherein the surface region is depleted of barium.

33. The polymer/dielectric composite of claim 30, wherein the surface region is free of divalent metal.

34. The polymer/dielectric composite of claim 30, wherein the dielectric particles have a ratio of divalent metal concentration to tetravalent metal concentration of less than 0.980.

35. The polymer/dielectric composite of claim 30, wherein the dielectric particles have a ratio of divalent metal concentration to tetravalent metal concentration of less than 0.970.
